(19) United States
(12) Patent Application Publication
(10) Pub. No.: US 2013/0030781 A1
(43) Pub. Date: Jan. 31, 2013

(54) PROCESSING STIMULATION METHOD, DEVICE FOR THE SAME, AND PROGRAM FOR CAUSING A COMPUTER TO EXECUTE THE METHOD

(71) Applicants: Takashi Yoneda, Tokyo (JP); Takashi Kamiya, Tokyo (JP); Nobuyuki Takahashi, Tokyo (JP); Mahito Matsuura, Tokyo (JP); Kenji Iriguchi, Tokyo (JP)

(72) Inventors: Takashi Yoneda, Tokyo (JP); Takashi Kamiya, Tokyo (JP); Nobuyuki Takahashi, Tokyo (JP); Mahito Matsuura, Tokyo (JP); Kenji Iriguchi, Tokyo (JP)

(73) Assignee: MITSUBISHI ELECTRIC CORPORATION, Tokyo (JP)

(21) Appl. No.: 13/639,758

(22) PCT Filed: Apr. 7, 2010
(86) PCT No.: PCT/JP2010/002550

§ 371 Date: Oct. 5, 2012

(51) Int. Cl. G06G 7/48

(52) U.S. Cl. 703/6

(57) ABSTRACT

When a material shape model is separated in shear through processing, a shape model of a material in a state of being suspended remains in mid-air, and thus, interference is detected excessively. In order to prevent the excessive detection of interference, in a processing simulation method for generating a shape model of a processed material from a shape model of a material and a shape model of a tool processing area which is defined from a shape model of the tool and a movement path of the tool, the shape model of the material being separated into a plurality of shapes by processing is detected; a material shape to be cut-off is extracted from the separated material shapes; and the extracted material shape to be cut-off is excluded from subject of simulation.

### TECHNICAL FIELD

The present invention relates to a processing simulation method for generating a shape model of a processed material from a shape model of a material and a shape model of a tool processing area which is defined from a shape model of the tool and a movement path of the tool, a device for carrying out the processing simulation method and a program for causing a computer to execute the processing simulation method. More particularly, the present invention relates to a processing simulation method in a case where a shape model of a material is separated by processing, a device for carrying out the processing simulation method and a program for causing a computer to execute the processing simulation method.

### BACKGROUND ART

Conventionally, as a processing simulation device for generating/displaying a shape model of a processed material based on information of a material shape model, a tool shape model and a tool movement path, a device is known which generates and displays the shape model of the processed material by generating a shape model of a tool processing area which is an area that can be processed when the tool moves along the tool movement path and removing the shape model of the generated tool processing area from the material shape model in accordance with a removal operation. Further, a device is also known which detects interference between the shape model of the generated tool processing area and the material shape model, in a case where the tool movement path is provided not for processing but for rapidly moving (see, Patent Document 1).

### PRIOR ART DOCUMENT

### Patent Document

Patent Document 1: JP-A-2001-356804

### DISCLOSURE OF THE INVENTION

### Problems that the Invention is to Solve

In the conventional processing simulation device as mentioned above, a shape model of a material is separated into a plurality of shapes and all of the separated plurality of shapes is considered as a subject of interference detection when a tool movement path shears through a material illustrated in FIG. 15. In this case, since a shape model of a material that is not present in actual processing remains in a state of being suspended in mid-air after the material is subjected to the shear-through processing, it was difficult to obtain correct interference detection result. For example, as illustrated in FIG. 16, there is a problem of obtaining a processing simulation result in which a shank part of the tool interferes with a shape model of a material in a state of being suspended in mid-air that is not present in actual processing when the material is processed by moving a tool in a direction perpendicular to the cutting-through direction of the material after processing illustrated in FIG. 15. This is because a shape model of a material which should originally be cut-off is not appropriately recognized in a processing simulation device.

The present invention has been made to solve the above-described problems and an object of the present invention is to provide a processing simulation method which is capable of correctly detecting interference between a tool processing area and the shape model of a material by recognizing a shape model of a material to be cut-off. Further, the present invention provides a device for carrying out the processing simulation method and a program for causing a computer to execute the processing simulation method.

### Means for Solving the Problem

In order to accomplish the above-described object, the present invention provides a processing simulation method for generating a shape model of a processed material from a shape model of a material and a shape model of a tool processing area which is defined from a shape model of the tool and a movement path of the tool, the processing simulation method including: detecting that the shape model of the material is separated into a plurality of shapes by processing; extracting a material shape to be cut-off from the separated material shapes; and excluding the extracted material shape to be cut-off from subject of simulation.

Further, the present invention provides a processing simulation device for generating a shape model of a processed material from a shape model of a material and a shape model of a tool processing area which is defined from a shape model of the tool and a movement path of the tool, the processing simulation device including: a means for detecting that the shape model of the material is separated into a plurality of shapes by processing; a means for extracting a material shape to be cut-off from the separated material shapes; and a means for excluding the extracted material shape to be cut-off from subject of simulation.

### Advantage of the invention

According to the present invention, there is an advantage that the shape model of processed material is formed in a correct shape and it is possible to properly detect interference between the tool processing area and the shape model of the material by excluding a shape model of a material to be cut-off from simulation subject when the shape model of a material is separated into a plurality of shapes.

### BRIEF DESCRIPTION OF THE DRAWINGS

FIG. 1 is a configuration view of a processing simulation device according to an embodiment 1 of the present invention.

FIG. 2 is a view for explaining an operation of a processed material generation unit of the processing simulation device according to the embodiment 1 of the present invention.

FIG. 3 is a view for explaining an operation of a shape separation detection unit of the processing simulation device according to the embodiment 1 of the present invention.

FIG. 4 is a flowchart illustrating an operation of the processing simulation device according to the embodiment 1 of the present invention.

FIG. 5 is a view illustrating a material shape model prior to processing in the processing simulation device according to the embodiment 1 of the present invention.

FIG. 6 is a view for explaining an operation of a processed material generation unit of the processing simulation device according to the embodiment 1 of the present invention.

FIG. 7 is a flowchart for explaining an operation of a shape separation detection unit of the processing simulation device according to the embodiment 1 of the present invention.

FIG. 8 is a view for explaining an operation of a tool interference detection unit of the processing simulation device according to the embodiment 1 of the present invention.

FIG. 9 is a view for explaining an operation of a cut-off shape extraction/removal unit of the processing simulation device according to the embodiment 1 of the present invention.

FIG. 10 is a configuration view of a processing simulation device according to an embodiment 2 of the present invention.

FIG. 11 is a view for explaining an operation of the processing simulation device according to the embodiment 2 of the present invention.

FIG. 12 is a view for explaining an operation of a processing simulation device according to the embodiment 3 of the present invention.

FIG. 13 is a view for explaining an operation of a processing simulation device according to the embodiment 4 of the present invention.

FIG. 14 is a view for explaining an operation of a processing simulation device according to the embodiment 5 of the present invention.

FIG. 15 is a view for explaining an operation of a conventional processing simulation device.

FIG. 16 is a view for explaining a problem of a conventional processing simulation device.

### BEST MODE FOR CARRYING OUT THE INVENTION

### Embodiment 1

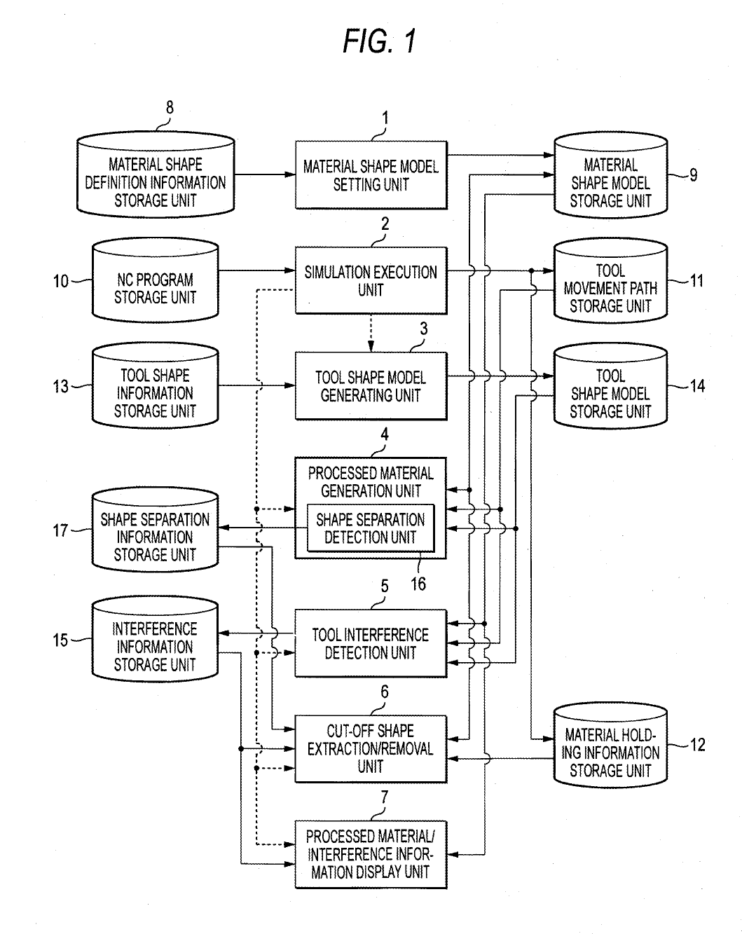

Hereinafter, the embodiment 1 of the present invention will be described by referring to FIGS. 1 to 9.

FIG. 1 illustrates a configuration of a processing simulation device according to the embodiment 1 of the present invention.

In FIG. 1, a material shape model setting unit 1 generates a material shape model before being processed from material shape definition information stored in a material shape definition information storage unit 8 and stores the generated material shape model in a material shape model storage unit 9.

A simulation execution unit 2 analyzes an NC program stored in an NC program storage unit 10 and stores tool movement path data obtained from the NC program in a tool movement path storage unit 11. Further, the simulation execution unit 2 stores material holding information (mounting of a workpiece on a first main spindle side and mounting of a workpiece on a second main spindle side) obtained from the NC program in a material holding information storage unit 12 and commands execution of processes of respective units, such as a tool model generation unit 3, a processed material generation unit 4, a tool interference detection unit 5, a cut-off shape extraction/removal unit 6 and a processed material/alarm display unit 7.

The tool shape model generation unit 3 generates a tool shape model from tool shape information stored in a tool shape information storage unit 13 in accordance with an execution command from the simulation execution unit 2 and stores the generated tool shape model in a tool shape model storage unit 14.

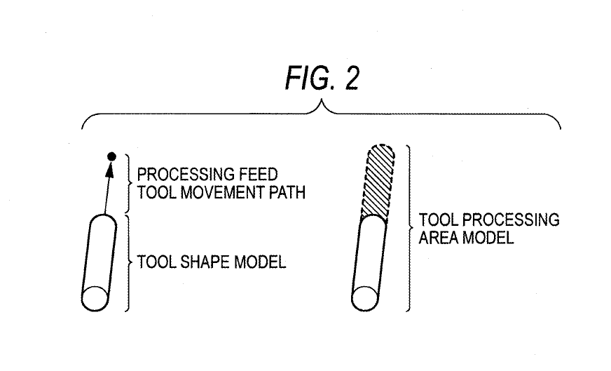

The processed material generation unit 4 generates a tool processing area shape model from the tool movement path data stored in the tool movement path storage unit 11 and the tool shape model stored in the tool shape model storage unit 14 in accordance with an execution command from the simulation execution unit 2, as illustrated in FIG. 2. Further, the processed material generation unit 4 generates a material shape model after being processed by removing the generated tool processing area shape model from the material shape model stored in the material shape model storage unit 9 in accordance with a removal operation and stores the generated material shape model after being processed in the material shape model storage unit 9.

A shape separation detection unit 16 (corresponding to a means for detecting that a material shape model is separated into a plurality of shapes by processing) stores separation information (separation detection flag, etc) in a shape separation information storage unit 17 when a condition for determining that the material shape model is separated is met during the removal operation.

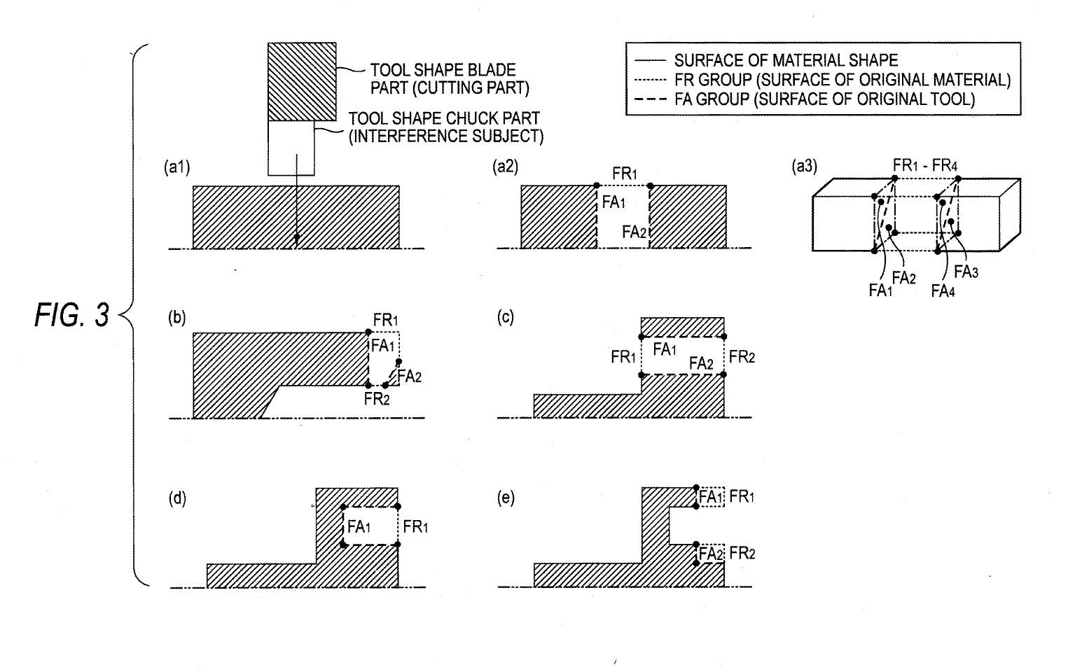

Hereinafter, a separation determining condition will be described by referring to FIG. 3.

First, surfaces constituting the tool processing area shape that is transferred to the material shape model, which are grouped together in a geometrically or topologically continuous unit, are referred to as an FA group (a material transferred tool processing area group). Further, surfaces constituting the material shape that is removed from the material shape model by processing, which are grouped together in a geometrically or topologically continuous unit, are referred to as an FR group (a processed material area group).

The separation determining condition refers to a condition in which ‘two or more FA groups are present and an FR group that is connected to the two or more FA groups is present’.

In FIG. 3(a), since two or more FA groups including a group of surface FA1 and surface FA2 and a group of surface FA3 and surface FA4 which are transferred from the tool processing area shape are present and a group of surfaces FR1 to FR4 of removed material shape is connected to two or more FA groups, separation is determined Further, since the separation determining condition mentioned above is met also in cases of FIG. 3(b) and FIG.(c), separation is determined, similarly.

Meanwhile, in FIG. 3(d), since only one FA group is present, separation is not determined. Further, in FIG. 3(e), since two or more FR groups that are connected to two or more FA groups not present, separation is not determined

The shape separation detection unit 16 included in the processed material generation unit 4 is only configured to determine separation of the material shape model. The material shape model itself is stored in the material shape model storage unit 9, together with a part of material shape separated by the processed material generation unit 4 as mentioned above.

The tool interference detection unit 5 generates a tool processing area shape model from the tool movement path data stored in the tool movement path storage unit 11 and the tool shape model stored in the tool shape model storage unit 14 in accordance with an execution command from the simulation execution unit 2 and detects interference between the generated tool processing area shape model and the material shape model stored in the material shape model storage unit 9. The tool interference detection unit 5 stores interference information (block information in the NC program with respect to the tool movement path at the time of interference) in an interference information storage unit 15 when the interference is detected.

The cut-off shape extraction/removal unit 6 (corresponding to a means which extracts a material to be cut-off from the separated material, means which excludes the extracted material to be cut-off from the subject of simulation and means which does not exclude the extracted the material to be cut-off from the subject of simulation at the time of improper processing) does not execute a cut-off shape extraction/removal processing when interference information is present in the interference information storage unit 15 and does not execute cut-off processing at the time of improper processing to prevent mistake in program. Further, the cut-off shape extraction/removal unit 6 extracts the separated material shape model as a cut-off shape, which is located at a opposite side to a mounting side of a material set in material holding information of the material holding information storage unit 12, among the material shape model stored in the material shape model storage unit 9, when interference information is not present in the interference information storage unit 15 and separation information is present in the shape separation information storage unit 17. The material shape model from which a shape extracted as the cut-off shape is removed is stored in the material shape model storage unit 9.

The processed material/interference information display unit 7 generates a shaded image of the material shape model stored in the material shape model storage unit 9 in accordance with an execution command from the simulation execution unit 2 and updates a shaded image on a display by the generated shaded image. Further, the content of the interference information is displayed on the display when the interference information is present in the interference information storage unit 15.

Components (simulation execution unit, tool shape model generation unit, etc.) of the simulation device other than the storage units (memories) is essentially constituted with a software and a hardware configuration thereof is generally constituted by CPU, memory, or the like.

Further, the simulation device may be installed and used in PC, digital control device, or the like.

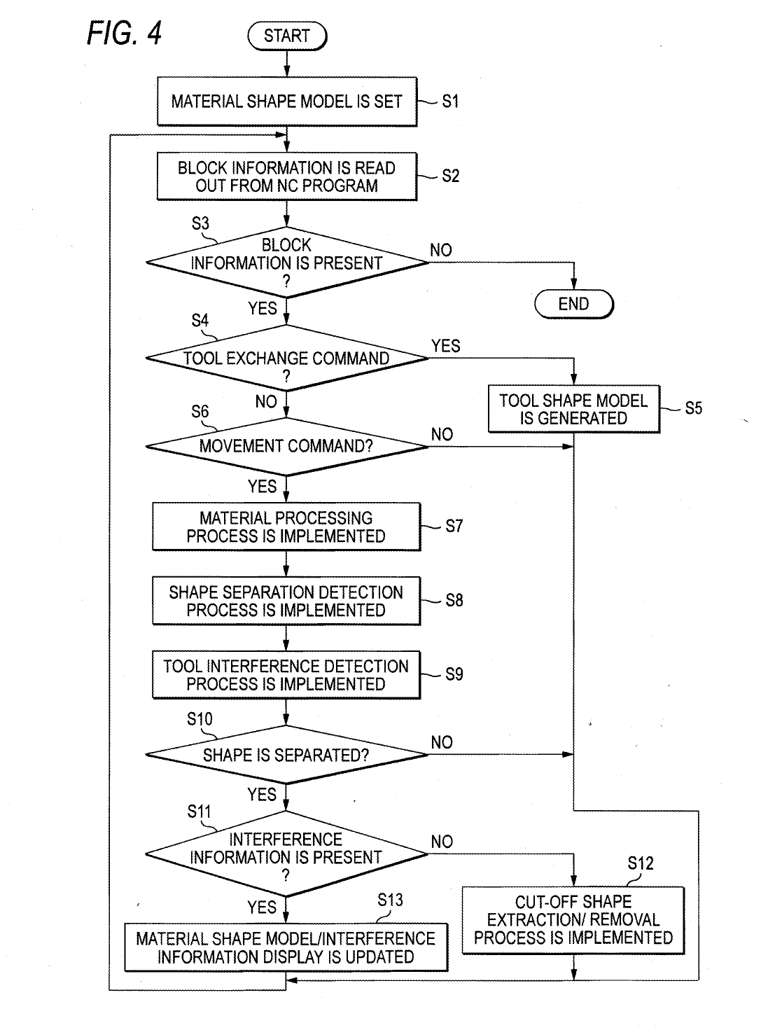

The processing simulation device thus configured is operated in accordance with the flowchart illustrated in FIG. 4.

In step S1, a material shape model before being processed is set from material shape definition information. Specifically, the material shape model setting unit 1 generates the material shape model before being processed from the material shape definition information stored in the material shape definition information storage unit 8 and stores the generated material shape model in the material shape model storage unit 9.

FIG. 5 is an example of case where the material shape model is set to a cuboid shape. Here, the material shape definition information includes a pattern (cuboid), positions (Px, Py, Pz) and dimensions (Lx, Ly, Lz) of the material shape.

In step S2, block information configuring the NC program is read out from the NC program. As the block information, there is information which commands the tool exchange, the tool movement, etc.

In step S3, it is checked whether the block information read out from the NC program is present or not. When the block information is not present, the whole process is ended. Otherwise, the process proceeds to step S4.

In step S4, it is checked whether the block information read out is directed to command the tool exchange or not. When the block information is directed to command the tool exchange, the process proceeds to step S5. Otherwise, the process proceeds to step S7.

In step S5, a tool shape model is generated in accordance with a number specified in the block information for the tool exchange. Specifically, the tool model generation unit 3 generates a tool shape model from tool shape information stored in a tool shape information storage unit 13 in accordance with an execution command from the simulation execution unit 2 and stores the generated tool shape model in the tool shape model storage unit 14.

In step S6, it is checked whether the block information read out is directed to command the movement or not. When the block information is directed to command the movement, the process proceeds to step S7. Otherwise, the process proceeds to step S13. Steps 2 to 4 and step 6 are carried out essentially through the operation of the simulation execution unit 2.

In step S7, a tool processing area shape model is generated from the tool movement command and the tool shape model generated in step S5 and the material shape model is updated into a material shape model after being processed by removing the generated tool processing area shape model from the material shape model in accordance with a removal operation. Specifically, the processed material generation unit 4 generates a tool processing area shape model from the tool movement path data stored in the tool movement path storage unit 11 and the tool shape model stored in the tool shape model storage unit 14 in accordance with an execution command from the simulation execution unit 2, as illustrated in FIG. 2. Further, the processed material generation unit 4 generates a material shape model after being processed by removing the generated tool processing area shape model from the material shape model stored in the material shape model storage unit 9 in accordance with a removal operation and stores the generated material shape model after being processed in the material shape model storage unit 9.

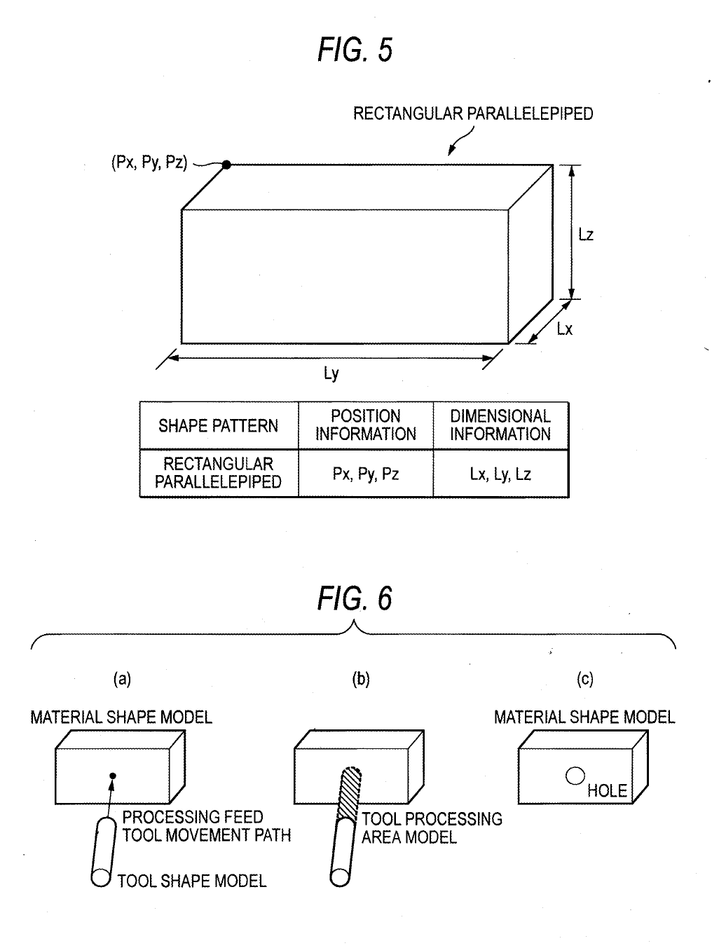

FIG. 6 illustrates an example of processing in step S7. FIG. 6(a) illustrates a relationship among the material shape model before being processed, the tool shape model and the tool movement path. FIG. 6(b) illustrates a state where the tool processing area shape model is generated from the tool shape model and the tool movement path. FIG. 6(c) illustrates the material shape model which is updated by removing the generated tool processing area shape model in accordance with a removal operation.

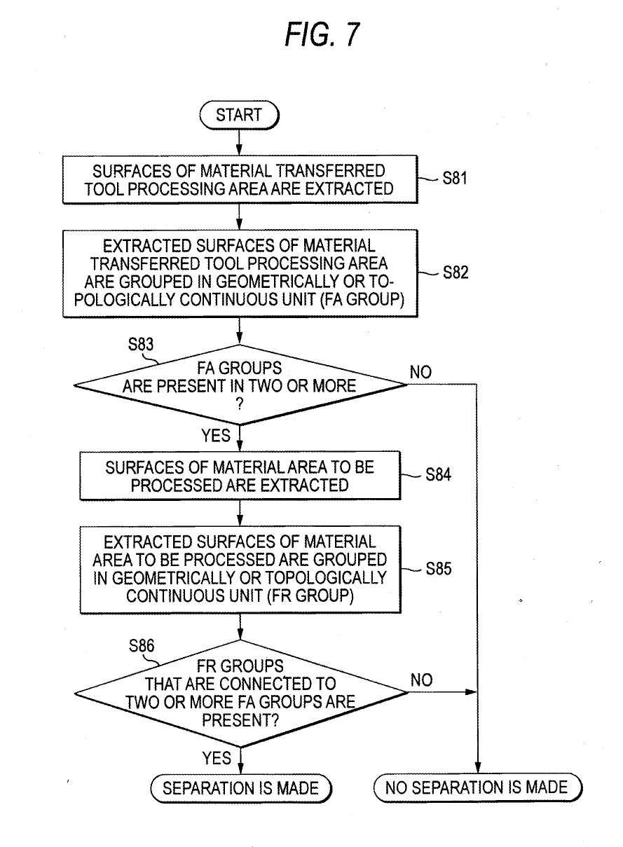

In step S8, the shape separation detection unit 16 determines whether the material shape model is separated or not based on a control flow illustrated in FIG. 7 and stores separation information (separation detection flag, etc) in the shape separation information storage unit 17 when a condition for determining that the material shape model is separated is met during the removal operation.

First, in step 81, surfaces constituting the tool processing area shape that is transferred to the material shape model are extracted. Next, in step 82, surfaces constituting the tool processing area shape that is transferred to the extracted material shape model are grouped together in a geometrically or topologically continuous unit to form a group (FA group). Next, in step 83, it is determined whether two or more FA groups are present or not. When two or more FA groups are not present, it is determined that the material shape is not separated and thus step S8 is ended.

When two or more FA groups are present, in step 84, surfaces constituting the material shape that is removed from the material shape model by processing are extracted. Next, in step 85, the extracted constituting surfaces are grouped together in a geometrically or topologically continuous unit to form a group (FR group). Next, in step 86, it is determined whether an FR group that is connected to the two or more FA groups is present or not. When an FR group that is connected to two or more FA groups is not present, it is determined that the material shape is not separated and thus step S8 is ended. When an FR group that is connected to the two or more FA groups is present, it is determined that the material shape is separated and separation information is stored in the shape separation information storage unit 17, and step S8 is ended.

In step S9, the tool processing area shape model is generated from the tool movement command and the tool shape model generated in step S5 and an operation for detecting interference between the generated tool processing area shape model and the material shape model is executed. When the interference is detected, a position of the block information in the NC program where interference occurs is stored as interference information. Specifically, the tool interference detection unit 5 generates a tool processing area shape model from the tool movement path data stored in the tool movement path storage unit 11 and the tool shape model stored in the tool shape model storage unit 14 in accordance with an execution command from the simulation execution unit 2 and detects interference between the generated tool processing area shape model and the material shape model stored in the material shape model storage unit 9. The tool interference detection unit 5 stores the interference information (block information in the NC program with respect to the tool movement path at the time of interference) in the interference information storage unit 15 when the interference is detected.

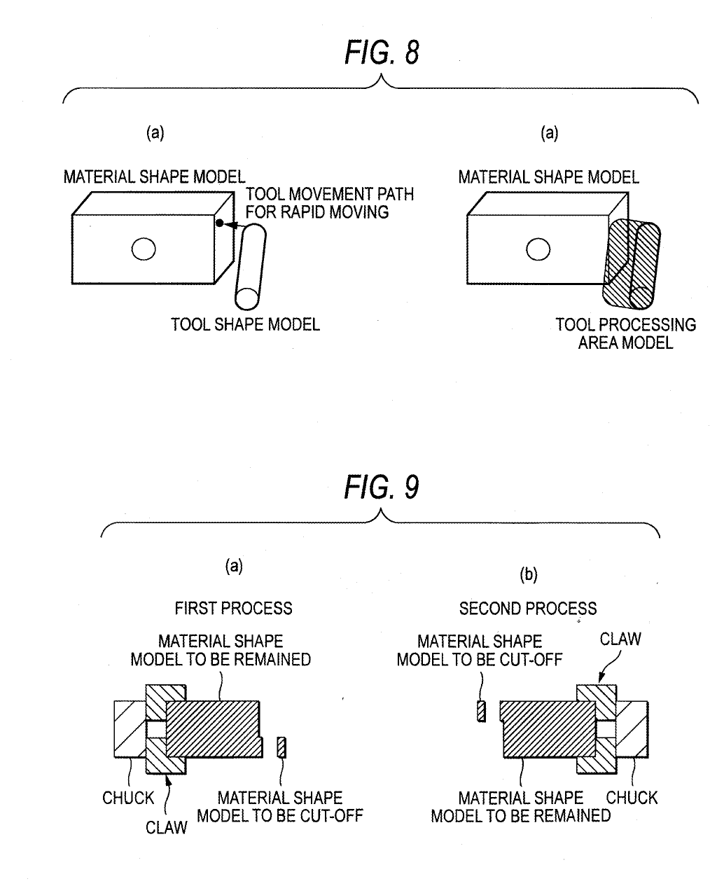

FIG. 8 illustrates an example of processing in step S9. FIG. 8(a) illustrates a relationship among the material shape model before being processed, the tool shape model for detecting interference and the tool movement path. FIG. 8(b) illustrates a state of the tool processing area shape model which is generated from the tool shape model and the tool movement path and the material shape model at the time of interference detection operation.

In step S10, when the separation information is present, the process proceeds to step S11. Otherwise, the process proceeds to step S13.

In step S11, when the interference information is not present, the process proceeds to step S12. Otherwise, the process proceeds to step S13.

In step S12, the separated material shape is classified into a remaining material shape model and a cut-off material shape model.

Steps 10 to 12 are carried out essentially through the operation of the cut-off shape extraction/removal unit 6. Specifically, the cut-off shape extraction/removal unit 6 extracts the separated material shape model as a cut-off shape, which is located at an opposite side to a mounting side of a material set in material holding information of the material holding information storage unit 12, among the material shape model stored in the material shape model storage unit 9 when separation information is present in the shape separation information storage unit 17 and interference information is not present in the interference information storage unit 15. And, the material shape model from which a shape extracted as the cut-off shape is deleted is stored in the material shape model storage unit 9.

Further, when the interference information is present in the interference information storage unit 15, the processing (cut-off shape extraction/removal) of step 12 is not executed. This is intended to prevent a mistake in the program by not executing the cut-off processing in improper processing.

FIG. 9 illustrates an example of processing in step S12. FIG. 9(a) illustrates a material shape model that is separated by processing in a state where the material is mounted on a first main spindle side. Here, the material shape model held in a jig such as a chuck, a claw, etc., becomes a remaining material shape model and the material shape model other than the remaining material shape model becomes a cut-off material shape model, based on the material holding information. The extracted material shape model to be cut-off is removed from the material shape model and the material shape model is updated. Further, FIG. 9(b) illustrates a material shape model that is separated by processing in a state where the material is mounted on a second main spindle side. Here, FIG. 9(b) illustrates an example of a case where the material shape model held in a jig such as a chuck, a claw, etc., becomes a remaining material shape model and the material shape model other than the remaining material shape model becomes a cut-off material shape model, based on the material holding information.

In step S13, a shaded image of the material shape model is generated and a shaded image on a display is updated by the generated shaded image. Further, the content of the interference information is displayed on the display when the stored interference information is present.

After step S13, the process returns to step S2 to read out next block information in the NC program. And then, the above steps are repeated until all of the blocks in the NC program are processed.

Hereinabove, the operation flow in the processing simulation device according to the embodiment 1 of the present invention has been described.

According to the embodiment 1, when the material shape model is separated by shear-through processing, etc., a shape model of a material in a state of being suspended in mid-air does not remain. Accordingly, there is an advantage that detection of unnecessary interference is prevented.

Further, when interference occurs at the time of processing to separate the shape, the cut-off processing is regarded as an improper processing and is not executed. Accordingly, there is an advantage of preventing a mistake in the program due to the cut-off processing.

### Embodiment 2

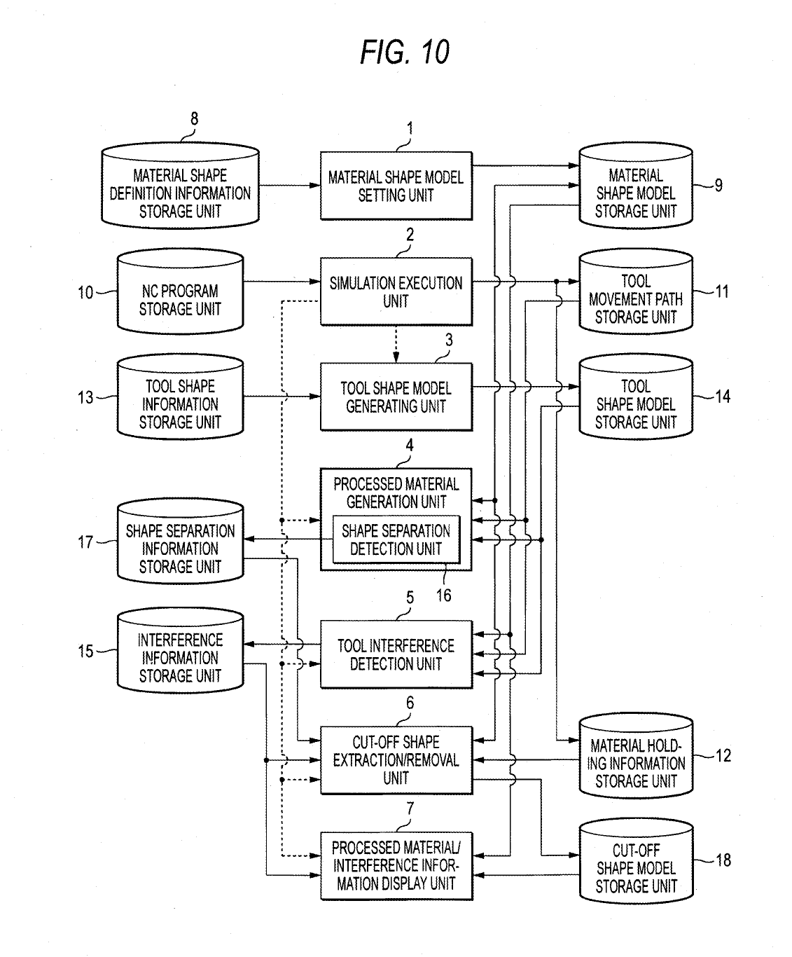

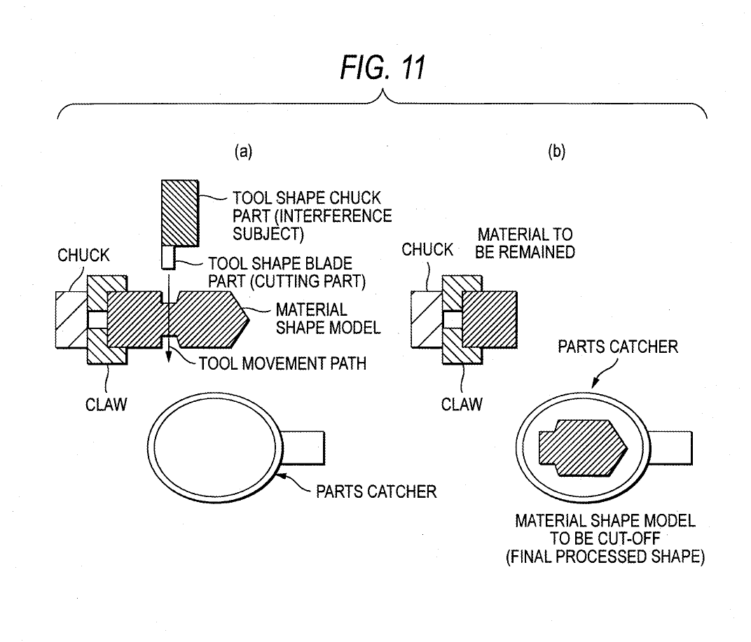

Next, the embodiment 2 of the present invention will be described by referring to FIGS. 10 and 11.

The embodiment 2 represents an example in which a cut-off shape model storage unit 18 is added to the embodiment 1, as illustrated in FIG. 10. In this way, a cut-off shape extracted by the cut-off shape extraction/removal unit 6 is stored in the cut-off shape model storage unit 18. After the simulation of the embodiment 1 is executed or when separation of a material shape is detected and thus the simulation is temporarily stopped, a list of a shape is displayed on a simulation display when a cut-off shape model is present in the cut-off shape model storage unit 18. In this way, a user selects any one in the list to display a cut-off material shape model on the display.

According to the embodiment 2, it is possible to confirm a final shape (processed shape) of a cut-off material on the display during a processing (FIG. 11) in which the processed material is cut-off and received by a parts catcher.

### Embodiment 3

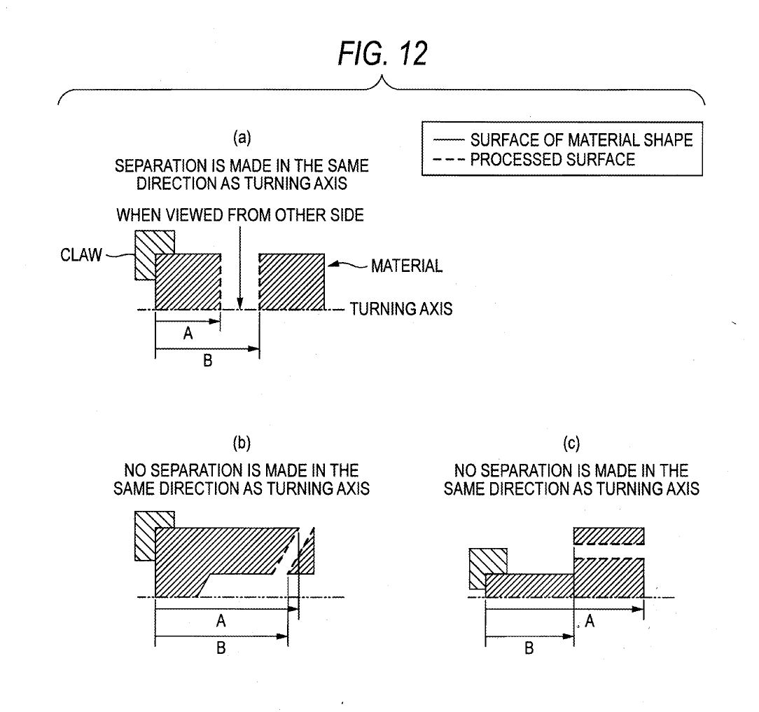

In the embodiment 1, the shape separation detection unit 16 determines separation when the group of adjacent surfaces of the material shape removed from the material shape, which is adjacent to two or more groups of adjacent surfaces of the tool processing area shape transferred to the material shape, is present. However, a condition may be used which determines separation when the processing is a cut-off processing that is actually carried out when the material shape is separated in the same direction as a turning axis in a turning processing, as illustrated in FIG. 12(a), and which does not determine separation when the material shape is not separated in the same direction as the turning axis and the processing is not proper as a turning processing, as illustrated in FIGS. 12(b) and (c). In FIG. 12, it is possible to determine whether the material shape is separated in the same direction as the turning axis or not by examining the relationship (A<B when the material shape is separated in the same direction as a turning axis and A>B when the material shape is separated in a direction other than the direction of a turning axis) between A dimension and B dimension, for example.

According to the embodiment 3, since the cut-off processing is performed only in proper processing and the cut-off processing is not performed in improper processing where it id determined that processing is not actually possible, there is an advantage of preventing a mistake in the program due to the cut-off processing. Further, since the determination is performed based on only the direction of the turning axis (one dimension), there is also an advantage of significantly reducing the amount of calculation.

### Embodiment 4

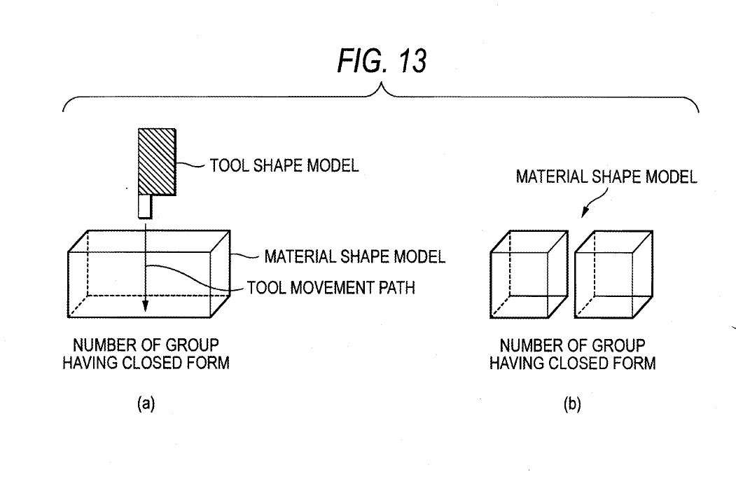

In the embodiment 1, the shape separation detection unit 16 determines separation when the group of adjacent surfaces of the material shape removed from the material shape, which is adjacent to two or more groups of adjacent surfaces of the tool processing area shape transferred to the material shape, is present. However, a condition may be used which determines separation in a case where a number of groups having a closed shape increases as a result of tracing connection relationship of surfaces constituting the material shape, as illustrated in FIG. 13.

### Embodiment 5

In the embodiment 1, a method may be used in which the cut-off shape extraction/removal unit 6 extracts the material shape model to be cut-off from the separated material shape model based on predetermined information.

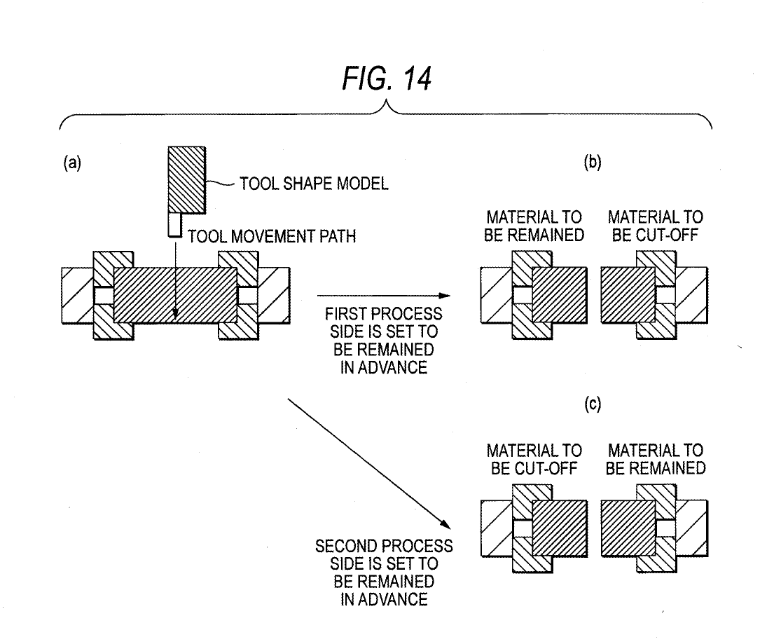

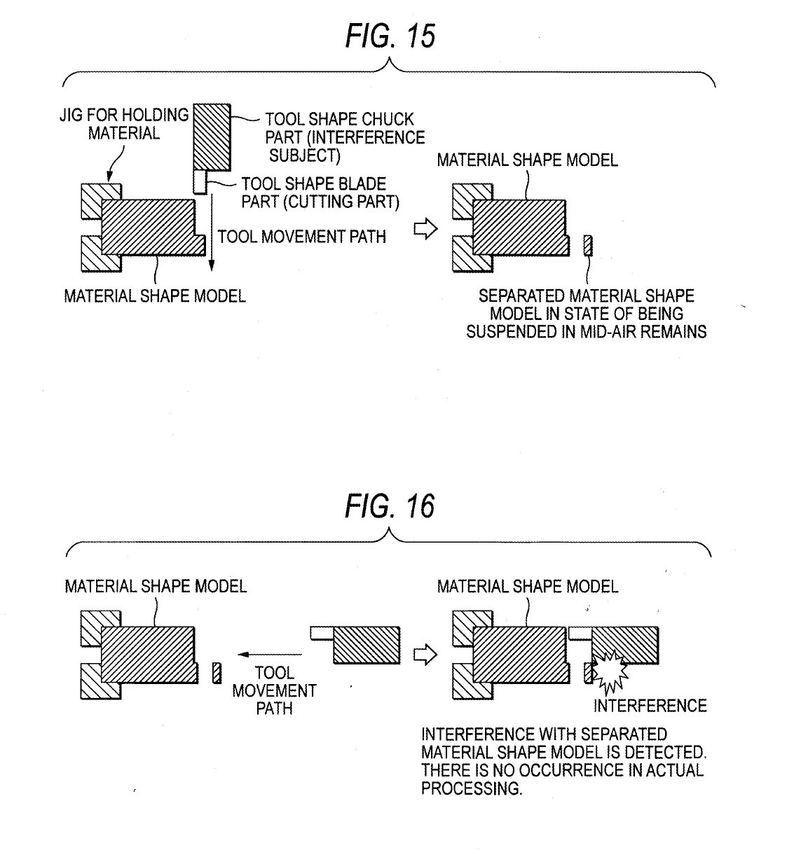

For example, in the processing where the material shape is separated as illustrated in FIG. 4(a), the material shape on the first main spindle side may remain and all of the material on an opposite side thereof may be extracted as a material shape to be cut-off, as illustrated in FIG. 14(b), in a case where the material shape on the first main spindle side is set to remain in advance (this information is set in the material holding information storage unit 12). Further, the material shape on the second main spindle side may remain and all of the material on an opposite side thereof may be extracted as a material shape to be cut-off, as illustrated in FIG. 14(c), in a case where the material shape on the second main spindle side is set to remain in advance.

### Embodiment 6

In the embodiment 1, regarding the extraction of the material shape model to be cut-off from the separated material shape model by the cut-off shape extraction/removal unit 6, the separated material shape model may be displayed on a display, a user may be caused to select a material model to be remained using a cursor and a keyboard, and based on a signal of the selection, materials other than the material to be remained may be extracted as the material to be cut-off. Of course, the material to be cut-off may be extracted by causing a user to select the material to be cut-off.

### INDUSTRIAL APPLICABILITY

The processing simulation method, the device for carrying out the processing simulation method and the program for causing a computer to execute the processing simulation method according to the present invention may be used in a processing simulation device for performing verification of the NC program that is provided in a numerical control device and further may be suitable to be used as a processing simulation method for predicting and preventing interference between the processed material and the tool during the operation of a machine tool, a device for carrying out the processing simulation method and a program for causing a computer to execute the processing simulation method.

### DESCRIPTION OF REFERENCE NUMERALS AND SIGNS

1 MATERIAL SHAPE MODEL SETTING UNIT,

2 SIMULATION EXECUTION UNIT,

3 TOOL SHAPE MODEL GENERATION UNIT,

4 PROCESSED MATERIAL GENERATION UNIT,

5 TOOL INTERFERENCE DETECTION UNIT,

6 CUT-OFF SHAPE EXTRACTION/REMOVAL UNIT,

7 PROCESSED MATERIAL/INTERFERENCE INFORMATION DISPLAY UNIT,

8 MATERIAL SHAPE DEFINITION INFORMATION STORAGE UNIT,

9 MATERIAL SHAPE MODEL STORAGE UNIT,

10 NC PROGRAM STORAGE UNIT,

11 TOOL MOVEMENT PATH STORAGE UNIT,

12 MATERIAL HOLDING INFORMATION STORAGE UNIT,

13 TOOL SHAPE INFORMATION STORAGE UNIT,

14 TOOL SHAPE MODEL STORAGE UNIT,

15 INTERFERENCE INFORMATION STORAGE UNIT,

16 SHAPE SEPARATION DETECTION UNIT,

17 SHAPE SEPARATION INFORMATION STORAGE UNIT,

18 CUT-OFF SHAPE MODEL STORAGE UNIT

1. A processing simulation method for generating a shape model of a processed material from a shape model of a material and a shape model of a tool processing area which is defined from a shape model of the tool and a movement path of the tool, the processing simulation method comprising:
detecting that the shape model of the material is separated into a plurality of shapes by processing;
extracting a material shape to be cut-off from the separated material shapes; and
excluding the extracted material shape to be cut-off from subject of simulation
wherein shape separation is determined in one of the following cases:
when there are two or more material transferred tool processing area groups in which surfaces constituting the tool processing area shape that is transferred to the material shape are grouped together in a geometrically or topologically continuous unit, and a processed material area group in which surfaces constituting the material shape that is removed by processing are grouped together in a geometrically or topologically continuous unit and which is connected to two or more of the material transferred tool processing area groups,
when a number of material shape groups, which is a group of surfaces that constitute the material shape model and are geometrically or topologically continuous, increases, or
when the material shape is separated in a same direction as a direction of a turning axis.

2-23. (canceled)

24. The processing simulation method according to claim 1,
wherein shape separation is not determined in a case where the material shape is separated in a direction other than the direction of the turning axis.

25. The processing simulation method according to claim 1,
wherein the material shape to be cut-off is extracted based on holding information of the material at the time of being separated.

26. The processing simulation method according to claim 1,
wherein the material shape to be cut-off is extracted based on holding information of the material which is set as a side to be cut-off in advance.

27. A processing simulation method for generating a shape model of a processed material from a shape model of a material and a shape model of a tool processing area which is defined from a shape model of the tool and a movement path of the tool, the processing simulation method comprising:
detecting that the shape model of the material is separated into a plurality of shapes by processing;
displaying a shape model of the separated material on a display so as to cause a user to select a material shape to be remained as the subject of simulation or the material shape to be cut-off;
extracting the material shape to be cut-off based on a signal selected by the user; and
excluding the extracted material shape to be cut-off from subject of simulation.

28. A processing simulation method for generating a shape model of a processed material from a shape model of a material and a shape model of a tool processing area which is defined from a shape model of the tool and a movement path of the tool, the processing simulation method comprising:
detecting that the shape model of the material is separated into a plurality of shapes by processing;
extracting a material shape to be cut-off from the separated material shapes; and
excluding the extracted material shape to be cut-off from subject of simulation at the time of proper processing,
wherein the extracted material shape to be cut-off is not excluded from the subject of simulation at the time of improper processing.

29. A processing simulation method for generating a shape model of a processed material from a shape model of a material and a shape model of a tool processing area which is defined from a shape model of the tool and a movement path of the tool, the processing simulation method comprising:
detecting that the shape model of the material is separated into a plurality of shapes by processing;
extracting a material shape to be cut-off from the separated material shapes; and
excluding the extracted material shape to be cut-off from subject of simulation
wherein the extracted material shape to be cut-off is stored and the stored material shape to be cut-off is displayed on a display.

30. A recording medium that stores a program for causing a computer to execute the method according to claim 1.

31. A processing simulation device for generating a shape model of a processed material from a shape model of a material and a shape model of a tool processing area which is defined from a shape model of the tool and a movement path of the tool, the processing simulation device comprising:
a means for detecting that the shape model of the material is separated into a plurality of shapes by processing;
a means for extracting a material shape to be cut-off from the separated material shapes; and
a means for excluding the extracted material shape to be cut-off from subject of simulation,
wherein the means for detecting that the shape model of the material is separated into a plurality of shapes by processing determines shape separation in one of the following cases:
when there are two or more material transferred tool processing area groups in which surfaces constituting the tool processing area shape that is transferred to the material shape are grouped together in a geometrically or topologically continuous unit, and a processed material area group in which surfaces constituting the material shape that is removed by processing are grouped together in a geometrically or topologically continuous unit and which is connected to two or more of the material transferred tool processing area groups,
when a number of material shape groups, which is a group of surfaces that constitute the material shape model and are geometrically or topologically continuous, increases, or
when the material shape is separated in a same direction as a direction of a turning axis.

32. The processing simulation device according to claim 31,
wherein the means for detecting that the shape model of the material is separated into a plurality of shapes by processing does not determine shape separation in a case where the material shape is separated in a direction other than a direction of a turning axis.

33. The processing simulation device according to claim 31,
wherein the means for extracting a material shape to be cut-off from the separated material shapes extracts a material shape to be cut-off based on holding information of the material at the time of being separated.

34. The processing simulation device according to claim 31,
wherein the means for extracting a material shape to be cut-off from the separated material shapes extracts the material shape to be cut-off based on holding information of the material which is set as a side to be cut-off in advance.

35. A processing simulation device for generating a shape model of a processed material from a shape model of a material and a shape model of a tool processing area which is defined from a shape model of the tool and a movement path of the tool, the processing simulation device comprising:
a means for detecting that the shape model of the material is separated into a plurality of shapes by processing;
a means for extracting a material shape to be cut-off from the separated material shapes; and
a means for excluding the extracted material shape to be cut-off from subject of simulation,
wherein the means for extracting a material shape to be cut-off from the separated material shapes extracts the material shape to be cut-off based on a signal relating to a material shape to be remained as the subject of simulation or a material shape to be cut-off that is selected by a user from the shape model of the separated material that is displayed on a display.

36. A processing simulation device for generating a shape model of a processed material from a shape model of a material and a shape model of a tool processing area which is defined from a shape model of the tool and a movement path of the tool, the processing simulation device comprising:
a means for detecting that the shape model of the material is separated into a plurality of shapes by processing;
a means for extracting a material shape to be cut-off from the separated material shapes; and
a means for excluding the extracted material shape to be cut-off from subject of simulation,
wherein the means for excluding the extracted material shape to be cut-off from the subject of simulation does not exclude the extracted material shape to be cut-off from the subject of simulation at the time of improper processing.

37. A processing simulation device for generating a shape model of a processed material from a shape model of a material and a shape model of a tool processing area which is defined from a shape model of the tool and a movement path of the tool, the processing simulation device comprising:
a means for detecting that the shape model of the material is separated into a plurality of shapes by processing;
a means for extracting a material shape to be cut-off from the separated material shapes;
a means for excluding the extracted material shape to be cut-off from subject of simulation; and
a means for storing the extracted material shape to be cut-off in a cut-off shape model storage unit and displaying the stored material shape to be cut-off on a display.
